(19) United States
(12) Patent Application Publication
(10) Pub. No.: US 2005/0190283 A1
(43) Pub. Date: Sep. 1, 2005

(54) Method and apparatus for macro-focus

(76) Inventors: Carmel Ish-Shalom, Alameda, CA (US); Selim S. Bencuya, Irvine, CA (US)

Correspondence Address: FARJAMI & FARJAMI LLP, 26522 LA ALAMEDA AVENUE, SUITE 360, MISSION VIEJO, CA, 92691, US

(21) Appl. No.: 11/064,601

(22) Filed: Feb. 24, 2005

Related U.S. Application Data
(60) Provisional application No. 60/547,195, filed on Feb. 24, 2004.
(60) Provisional application No. 60/547,194, filed on Feb. 24, 2004.

(51) Int. Cl. H04N 5/225

(52) U.S. Cl. 348/340

(57) ABSTRACT

A device for arranging a distance between an optical element and an image sensor. The device includes a housing mechanically coupled to the optical element, a frame mechanically coupled to the housing, the frame having a first extension, and a base movably coupled to the frame, the base having a sloped first channel accommodating the first extension, the first channel having a first stop point and a second stop point, wherein the frame moves between the first stop point and the second stop point, which correspond to first and second distances between the optical element and the image sensor, respectively.

This application claims priority to U.S. Provisional Patent Application Ser. No. 60/547,195, filed on Feb. 24, 2004, and also claims priority to U.S. Provisional Patent Application 60/547,194, filed on Feb. 24, 2004. The disclosures of these applications are incorporated herein by reference.

### BACKGROUND

1. Technical Field

The present disclosure relates to a method and apparatus for macro-focus feature for a camera. More specifically, the present disclosure relates to a method and apparatus for macro-focus feature for a camera module in a portable device such as a cellular phone, personal digital assistant (PDA) or any device capable of capturing a digital image.

2. Background of the Invention

Macro-focus refers to a camera's ability to focus on a nearby object and may be achieved by repositioning a lens in the camera in order to focus on the nearby object. Such repositioning may be performed by moving a lens-barrel within a lens-mount in order to bring a lens within the lens-barrel to a macro-focus position. It may be desirable to include a macro-focus feature capable of focusing the lens at macro-focus and infinity-focus positions repeatedly and accurately. Providing this function in an accurate and repeatable manner while allowing for size and cost considerations may be challenging, especially in implementations such as cellular phones or PDA's.

With a macro-focus feature, the lens-barrel may move between the two or more focus positions. However, variations in the manufacturing process may produce slack, thereby negatively affecting the repeatability and accuracy of the movement of the lens-barrel into the focus positions.

### SUMMARY

The present disclosure relates to a method and apparatus for arranging a distance between an optical element and an image sensor, comprises a housing mechanically coupled to the optical element, a frame mechanically coupled to the housing, the frame having a first extension, and a base movably coupled to the frame, the base having a sloped first channel accommodating the first extension, the first channel having a first stop point and a second stop point, wherein the frame moves between the first stop point and the second stop point, which correspond to first and second distances between the optical element and the image sensor, respectively.

In another aspect, the frame includes a cantilever extension, and the base includes a sloped cantilever channel accommodating the cantilever extension.

In another aspect, the cantilever channel has substantially the same slope as the first channel, the cantilever channel is at least as long as the first channel, and the cantilever channel and first channel are separated by a predetermined distance, and the first extension and the cantilever extension are separated by the predetermined distance.

### BRIEF DESCRIPTION OF THE DRAWINGS

The foregoing features and other aspects of the present disclosure are explained in the following description taken in connection with the accompanying drawings, wherein:

FIG. 1 is a view of a camera module having a macro-focus feature, according to one aspect of the present disclosure.

FIGS. 2A and 2B are views of a lens-barrel, according to one aspect of the present disclosure.

FIGS. 3A, 3B and 3C are views of a lens-mount, according to one aspect of the present disclosure.

FIGS. 4A, 4B, 4C and 4D are views of a macro-ring, according to one aspect of the present disclosure.

FIG. 5 is a view of a button, according to one aspect of the present disclosure.

FIG. 6 is a perspective view of a lens-mount, according to another aspect of the present disclosure.

FIGS. 7A, 7B, 7C, 7D and 7E are top, bottom, side, and cross-section views of a lens-mount, according to another aspect of the present disclosure.

FIG. 8A is a side cross-sectional view of a lens-mount according to another aspect of the present disclosure.

FIG. 8B is a top detail view of the lens-mount according to another aspect of the present disclosure.

FIG. 9A is a side view of a lens-mount according to another aspect of the present disclosure.

FIG. 9B is a view of a slot according to another aspect of the present disclosure.

FIG. 10 is a perspective view of a macro-ring, according another aspect of the present disclosure.

FIGS. 11A, 11B and 11C are side and top views of a macro-ring, according another aspect of the present disclosure.

FIGS. 12A, 12B, 12C, and 12D are top and side views of a macro-ring, according another aspect of the present disclosure.

FIGS. 12E and 12F are top cross-section views of tab and button according to another aspect of the present disclosure.

### DETAILED DESCRIPTION

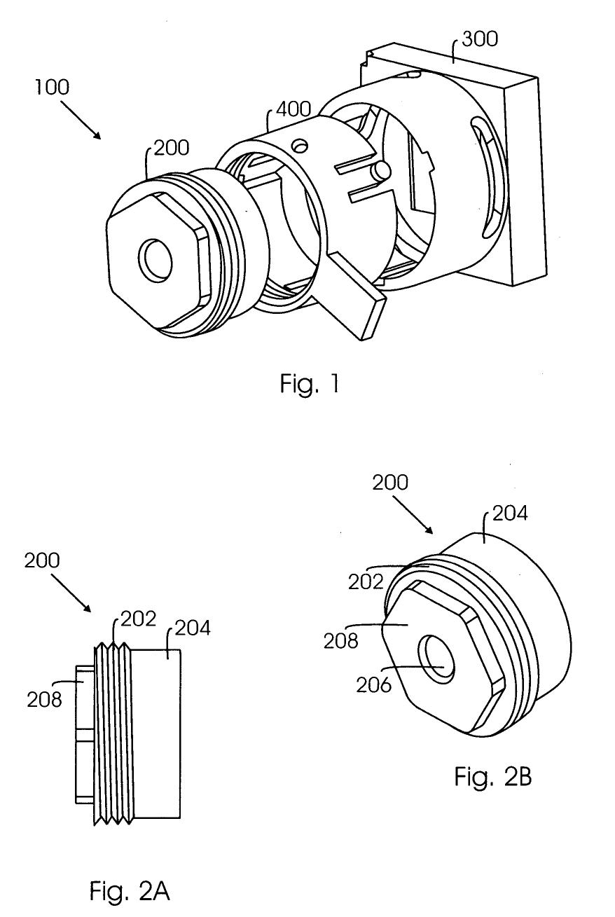

FIG. 1 is a view of a camera module having a macro-focus feature, according to one aspect of the present disclosure. Camera module 100 may include lens-barrel 200, lens-mount 300, and macro-ring 400. Lens-barrel 200 may be secured to macro-ring 400, and macro-ring 400 may be movably attached to lens-mount 300.

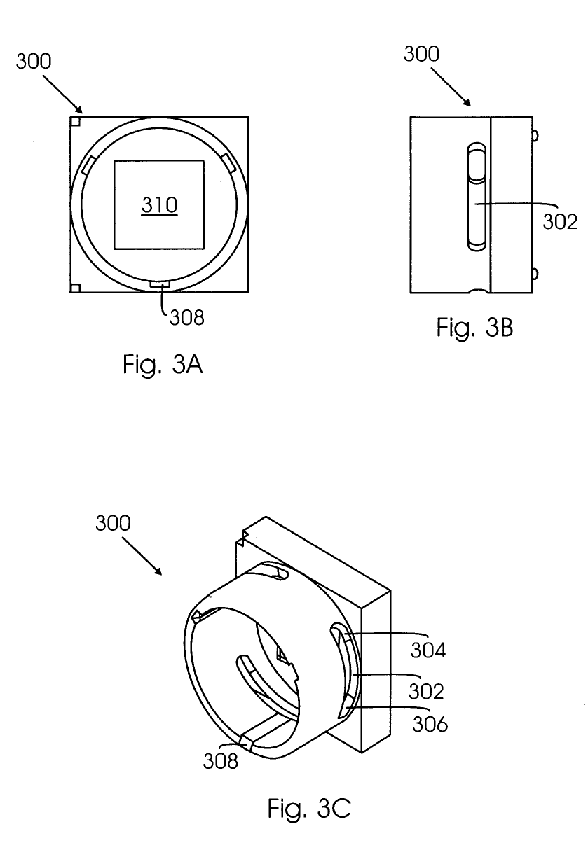

FIGS. 2A and 2B are views of a lens-barrel, according to one aspect of the present disclosure. Lens-barrel 200 may include lens-barrel threads 202. Section 204 of lens-barrel 200 may be partially flat and may provide for axial self-aligning lens-barrel 200 to macro-ring 400. Opening 206 may permit light to pass to lens (not shown) located within lens-barrel 200. Raised portion 208 may be a shape, such as an hexagon, and may be used as a contact point used to move lens-barrel 200, for example, during assembly and calibration.

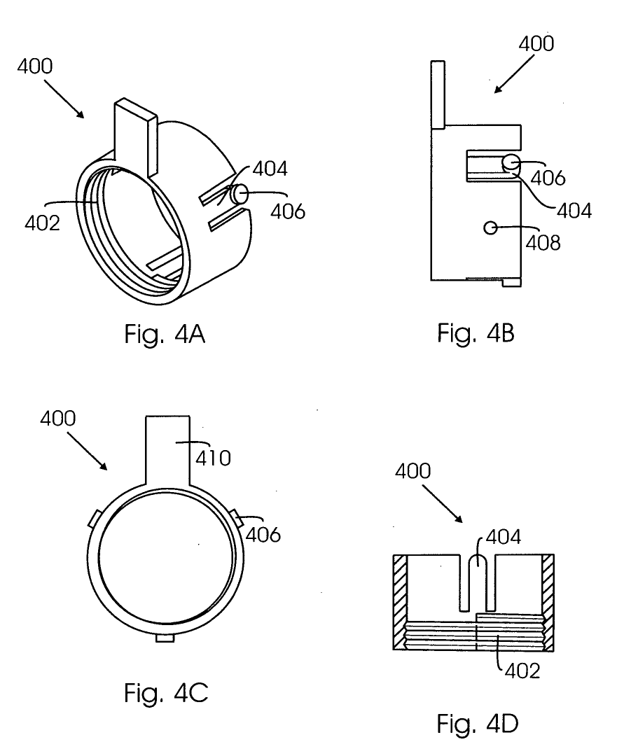

FIGS. 3A, 3B and 3C are views of a lens-mount according to one aspect of the present disclosure. Lens-mount 300 may include one or more sloped channels 302. Channel 302 may include focus stops 304 and 306 corresponding to focus positions, for example infinity and macro-focus. Focus stops 304 and 306 may be detents or depressions molded into lens-mount 300 and may provide positive locking stopping points for the movement of macro-ring 400. Additional detents may be added, providing intermediate focus positions. In another aspect, channel 302 may be substantially vertically oriented.

As macro-ring 400 moves, channel 302 in lens-mount 300 guides macro-ring 400 and lens-barrel 200 toward or away from the image sensor (not shown), depending on the direction of movement, thereby changing the focus distance. The slope of channel 302 determines the amount of movement necessary to move between focus positions.

Slot 308 may facilitate insertion of tab 404 and button 406 into the channels 302. Lens-mount 300 may act as a cover for the image sensor (not shown), and opening 310 may permit light to pass to the image sensor (not shown).

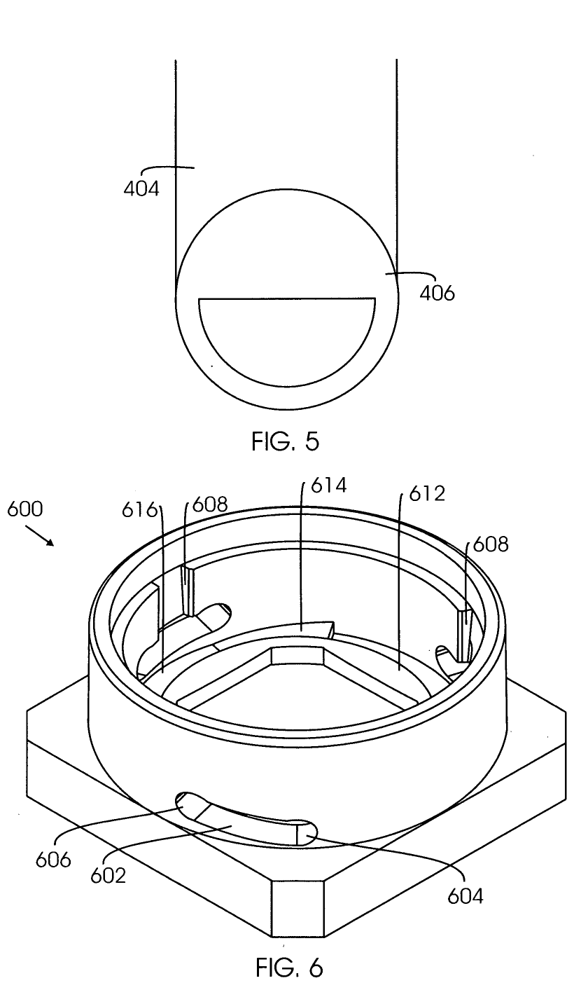

FIGS. 4A, 4B, 4C and 4D are views of a macro-ring, according to one aspect of the present disclosure. Macro-ring 400 may have internal threads 402 for threading with lens-barrel threads 202. Macro-ring 400 may have one or more tabs 404, each with button 406. Tab 404 may flex inward when inserted into lens-mount 300, until button 406 reaches channels 302.

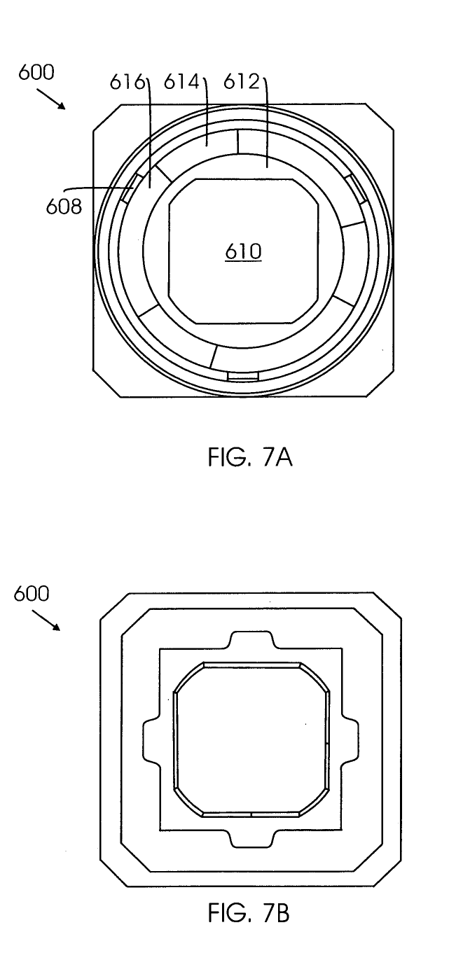

Each button 406 may be shaped to provide a spring action to allow for positive locking in the focus positions. An example of button 406 is shown in FIG. 5. When lens-barrel 200 is inserted into macro-ring 400, tabs 404 may not retract due to mechanical interference with lens-barrel 200, thereby preventing macro-ring 400 from exiting lens-mount 300.

Holes 408 in macro-ring 400 may be openings for glue and/or heat staking macro-ring 400 to lens-barrel 200.

Interface 410 may provide for physical control of macro-ring 400 and the macro-focus feature. In one aspect, interface 410 may be a tab, as shown in FIGS. 4A, 4B and 4C. In another aspect, interface 410 may include teeth (not shown) that interface with a driving gear (not shown).

A camera module 100 having a macro-focus feature may be assembled as follows:

Macro-ring 400 may be inserted into lens-mount 300 and positioned in a focus position, for example, the infinity focus position.

Lens-barrel 200 may be inserted into macro-ring 400 by threading lens-barrel threads 202 with macro-ring threads 402. Image sensor (not shown) beneath lens-mount 300 may be contacted electrically and activated.

Lens-barrel 200 may be moved until an image obtained from the image sensor reaches best focus position for the given focus position, in this example, infinity.

Macro-ring 400 and lens-barrel 200 may be securely attached to each other by dropping glue into one or more holes 408 in macro-ring 400. After the glue is dispensed, macro-ring 400 may be heat staked to lens-barrel 200 to ensure robustness of the connection between macro-ring 400 and lens-barrel 200. In another aspect, heat staking may be sufficient for fixing lens-barrel 200 to macro-ring 400 without glue.

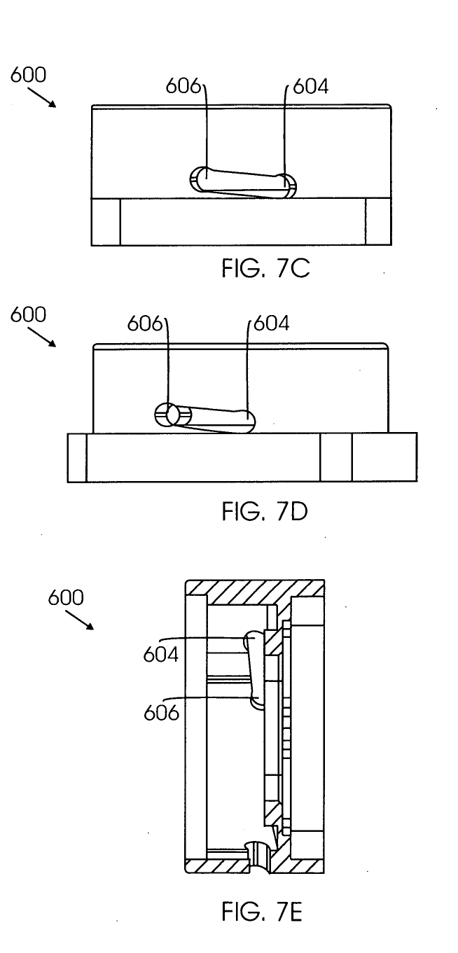

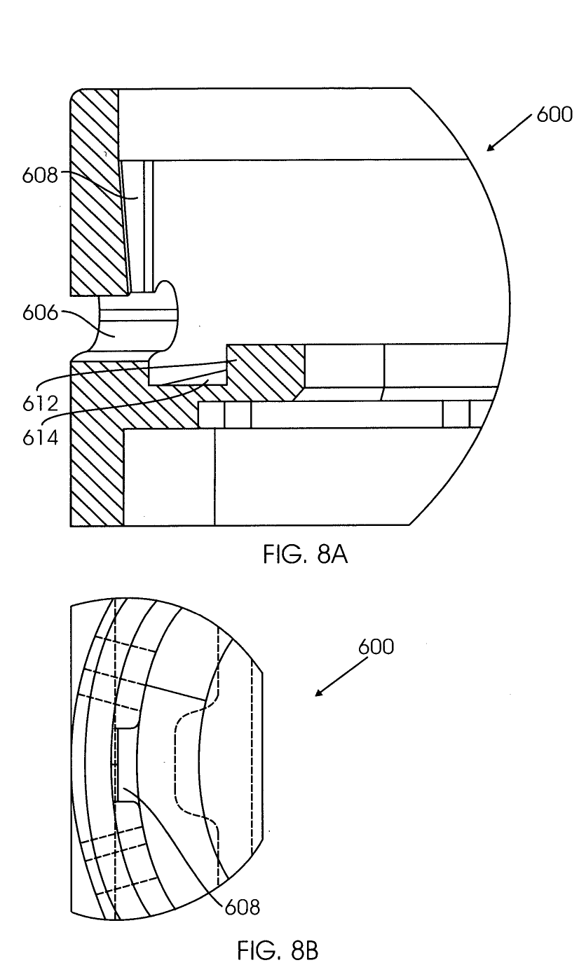

FIGS. 6, 7A-7E, 8A, 8B, 9A and 9B are views of a lens-mount, according to another aspect of the present disclosure. As shown in FIG. 6, lens-mount 600 may include one or more sloped channels 602. Each channel 602 may include focus stops 604 and 606 corresponding to focus positions, for example, macro-focus and infinity. Focus stops 604 and 606 may be detents or depressions molded into lens-mount 600 and may provide positive locking stopping points for the movement of macro-ring 1000. In one aspect, additional focus stops may be added, providing intermediate focus positions. In another aspect, channel 602 may be substantially vertically oriented. In one aspect, detents are located along a top portion of channel 602.

Lens-mount 600 may act as a cover for the image sensor (not shown), while opening 610 may permit light to pass to the image sensor (not shown). Lens-mount 600 may include a raised platform 612 surrounding opening 610 at the bottom of the lens-mount cavity which may prevent flashing or other particulates from reaching the lens or image sensor (not shown).

Lens-mount 600 may include a sloped cantilever channel ramp 614 that contacts and maintains constant force against cantilever spring 1012 through cantilever spring interface 1014, located on macro-ring 1000, as described below. The lengths and arrangements of channel 602 and cantilever channel ramp 614 may be related so that cantilever spring interface 1014 is in contact with cantilever channel ramp 614 as tab 1004 and button 1006 move along channel 602.

Following in a circular pattern around platform 612, at the end of cantilever channel ramp 614 there may be a substantially horizontal trench 616. Following trench 616 may be another cantilever channel ramp 614 and so on. Each cantilever channel ramp 614 and trench 616 combination may correspond to a channel 602.

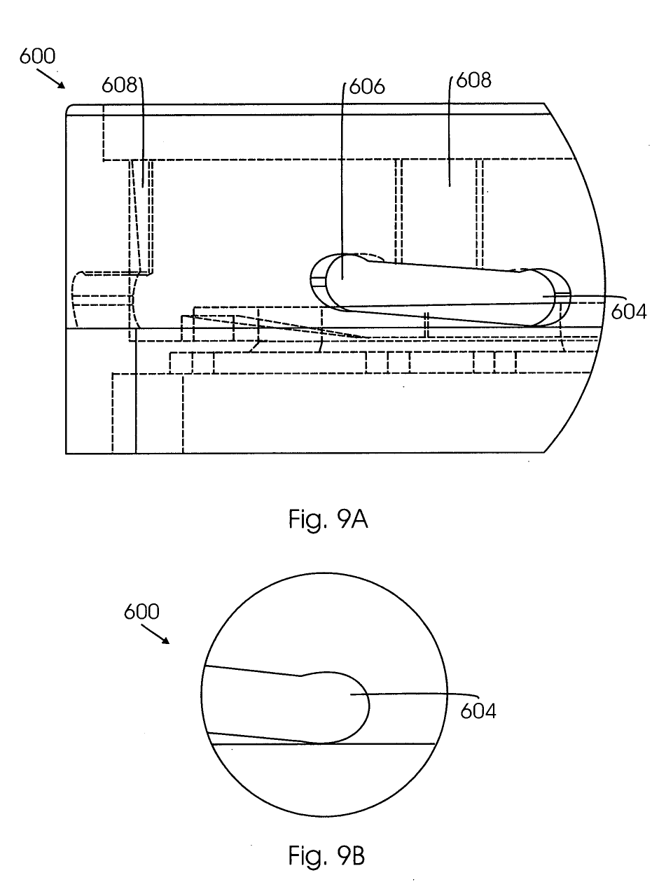

As shown in FIG. 8A, cantilever channel ramp 614 and trench 616 may be located at a height lower than platform 612, and flashing or particulates may collect there. Oil, grease or other substances likely to retain flashing or particulates may be added to cantilever channel ramp 614 and/or trench 616 to prevent flashing or particulates from crossing platform 612 and reaching opening 610 and image sensor (not shown).

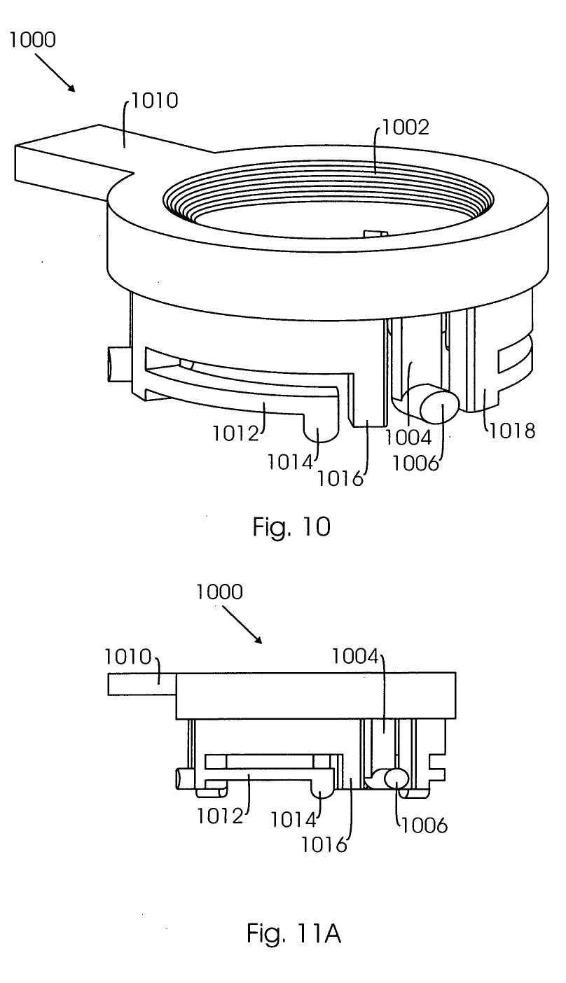

As shown in FIGS. 8A, 8B and 9A lens-mount 600 may include slot 608 with sloped edge surface having increasing thickness in a downward direction, thereby providing increasing force against tab 1004 and button 1006 during insertion of button 1006 of macro-ring 1000 into channel 602 of lens-mount 600.

As the macro-ring 1000 moves, for example, rotates, channel 602 in lens-mount 600 guides macro-ring 1000 and lens-barrel 200 toward or away from the image sensor (not shown), depending on the direction of movement, thereby changing the focus distance. The slope of channel 602 determines the movement necessary to move between focus positions.

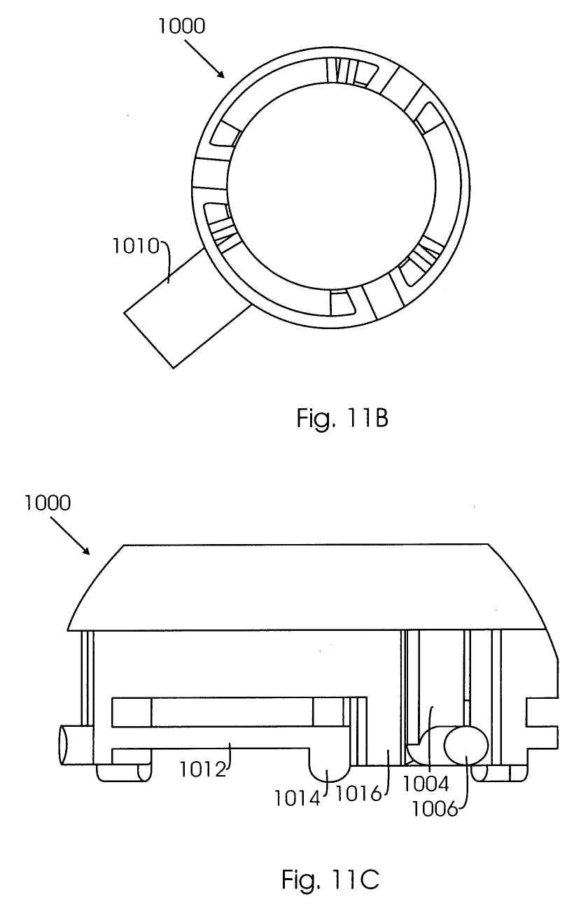

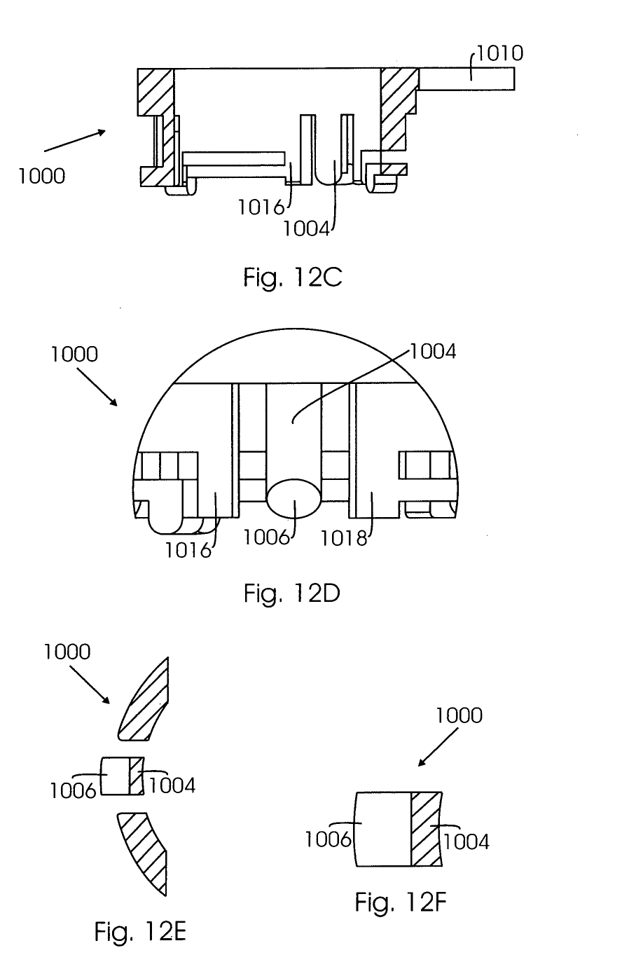

FIGS. 10, 11A-11C and 12A-12F are views of a macro-ring, according to another aspect of the present disclosure.

Macro-ring 1000 may have one or more cantilever springs 1012 each with a cantilever spring interface 1014. Cantilever spring 1012 may ensure that button 1006 moves along a top surface of channel 602 by applying force on cantilever channel ramp 614. Cantilever spring 1012 assists pushing button 1006 into focus stops 604 and 606, or any intermediate focus stops as provided. Cantilever spring 1012 may flex upward when macro-ring 1000 is inserted into the lens-mount.

Macro-ring 1000 may have internal threads 1002 for threading with lens-barrel threads 202. Macro-ring 1000 may have one or more tabs 1004, each with button 1006. Tab 1004 may flex inward when inserted along tapered portion of slot 608 into lens-mount 600, until button 1006 reaches channel 602.

Button 1006 may be shaped to provide a spring action to allow for positive locking in focus stops 604 and 606. When lens-barrel 200 is inserted into macro-ring 1000, tab 1004 may not retract due to mechanical interference with lens-barrel 200, thereby preventing macro-ring 1000 from exiting lens-mount 600.

Macro-ring 1000 may also have posts 1016 and 1018 that may make contact with lens-mount 600 when excess downward force is applied to macro-ring 1000, for example during insertion into lens-mount 600, thereby preventing damage to cantilever spring 1012 and tab 1004.

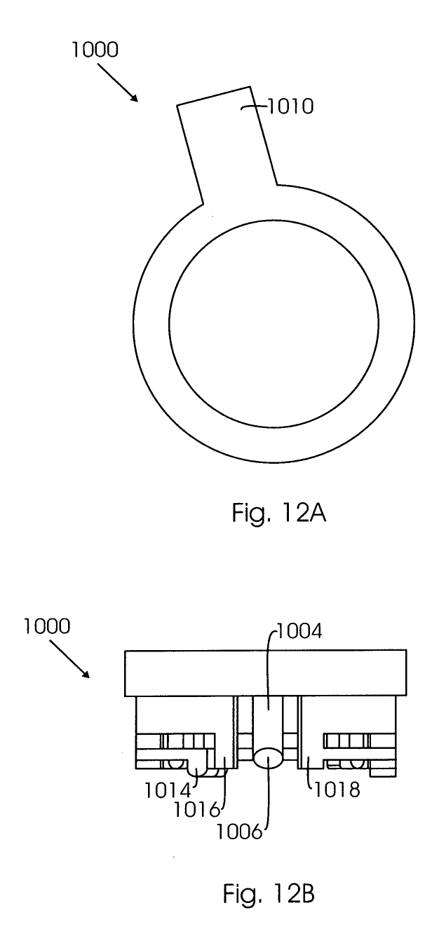

Interface 1010 may provide for physical control of macro-ring 1000 and the macro-focus feature. In one aspect, interface 1010 may be a tab, as shown in FIGS. 10, 11A and 11B. In another aspect, interface 1010 may include teeth (not shown) that interface with a driving gear (not shown).

A camera module having a macro-focus feature may be assembled as follows:

Macro-ring 1000 may be inserted into lens-mount 600 by aligning button 1006 with slot 608 and pressing together macro-ring 1000 and lens-mount 600. Tab 1004 may flex inward as button 1006 rides downward along slot 608 until button 1006 reaches channel 602. Once inserted into lens-mount 600, macro-ring 1000 may be moved, for example, rotated, thereby causing cantilever spring interface 1014 to slide along cantilever channel ramp 614 and causing button 1006 to move along a top surface of channel 602 until button 1006 reaches a focus stop, e.g. focus stop 604, which causes the macro-ring 1000 to stop moving.

Lens-barrel 200 may be inserted into macro-ring 1000 by threading lens-barrel threads 202 with macro-ring threads 1002.

The image sensor (not shown) beneath the lens-mount 600 may be contacted electrically and activated.

Lens-barrel 200 may be moved, for example, rotated, until an image obtained from the image sensor reaches best focus position for the given focus position.

Lens barrel 200 may be attached to macro-ring 1000 by glue, or it may be heat staked or attached by laser staking.

Although illustrative embodiments have been described herein in detail, it should be noted and will be appreciated by those skilled in the art that numerous variations may be made within the scope of this invention without departing from the principle of this invention and without sacrificing its chief advantages.

Unless otherwise specifically stated, the terms and expressions have been used herein as terms of description and not terms of limitation. There is no intention to use the terms or expressions to exclude any equivalents of features shown and described or portions thereof and this invention should be defined in accordance with the claims that follow.

1. A device for arranging a distance between an optical element and an image sensor, comprising:
a housing mechanically coupled to the optical element;
a frame mechanically coupled to the housing, the frame having a first extension; and
a base movably coupled to the frame, the base having a sloped first channel accommodating the first extension, the first channel having a first stop point and a second stop point,
wherein the frame moves between the first stop point and the second stop point, which correspond to first and second distances between the optical element and the image sensor, respectively.

2. The device of claim 1, wherein the frame includes a cantilever extension, and the base includes a sloped cantilever channel accommodating the cantilever extension.

3. The device of claim 2, wherein the base includes an opening and a platform surrounding the opening, and wherein the platform is at an elevation higher than the cantilever channel.

4. The device of claim 2, wherein the cantilever channel has substantially the same slope as the first channel, the cantilever channel is at least as long as the first channel.

5. The device of claim 4, wherein the cantilever channel and first channel are separated by a predetermined distance, and the first extension and the cantilever extension are separated by the predetermined distance.

6. The device of claim 1, wherein the optical element is a lens.

7. The device of claim 1, wherein the base includes a slot formed along a portion of a wall of the base and leading to the first channel.

8. The device of claim 1, wherein the base includes a slot leading to the first channel, the slot formed along a portion of a wall of the base having increasing thickness, thereby providing increasing force against the first extension during insertion of the first extension into the first channel.

9. The device of claim 1, wherein the first extension includes a tab having a button, and the first and second stop points are indentations in an upper surface of the first channel into which the button fits.

10. The device of claim 1, wherein the housing and the frame each have threads and are screwed together.

11. The device of claim 1, wherein the frame includes a protruding interface which provides for physical control of the frame.

12. The device of claim 1, wherein the frame includes a post which is substantially the same length as the first extension.

13. The device of claim 1, wherein the frame includes a post which is substantially the same length as the cantilever extension.

14. The device of claim 1, wherein the first stop point and the second stop point correspond to infinity and macro-focus positions, respectively.

15. The device of claim 1, wherein the first channel has a third stop point located between the first stop point and the second stop point, corresponding to a third distance between the optical element and the image sensor.

16. A method for arranging a distance between an optical element and an image sensor, comprising the steps of:
a) aligning a first extension of a frame with a slot formed along a wall of a base;
b) compressing the frame and the base together until the first extension enters a sloped first channel of the base;
c) moving the frame, causing the first extension to travel along the first channel and causing a cantilever extension of the frame to travel along a sloped cantilever channel of the base, until the first extension reaches a first stop point;
d) inserting into the frame a housing mechanically coupled to an optical element;
e) monitoring an output of the image sensor;
f) adjusting a distance between the housing and the image sensor until an image output of the image sensor substantially matches a desired image output; and
g) mechanically coupling the housing to the frame.

17. A method for arranging a distance between an optical element and an image sensor, comprising the step of:
rotating a frame that is mechanically coupled to a housing mechanically coupled to an optical element, thereby causing a first extension of the frame to travel along a sloped first channel of a base and also causing a cantilever extension of the frame to travel along a sloped cantilever channel of the base, until the first extension reaches a first stop point of the first channel.
